(19) United States
(12) Patent Application Publication
(10) Pub. No.: US 2024/0186693 A1
(43) Pub. Date: Jun. 6, 2024

(54) ANTENNA MODULE AND COMMUNICATION DEVICE

(71) Applicant: Murata Manufacturing Co., Ltd., Nagaokakyo-shi (JP)

(72) Inventors: Haruki MIYAGAWA, Nagaokakyo-shi (JP); Hideki UEDA, Nagaokakyo-shi (JP)

(73) Assignee: Murata Manufacturing Co., Ltd., Nagaokakyo-shi (JP)

(21) Appl. No.: 18/442,129

(22) Filed: Feb. 15, 2024

Related U.S. Application Data
(62) Division of application No. 17/383,456, filed on Jul. 23, 2021.
Application No. 17/383,456 is a continuation of application No. PCT/JP2019/050131, filed on Dec. 20, 2019.

(30) Foreign Application Priority Data
Jan. 23, 2019 (JP) 2019-009221

(51) Int. Cl. H01Q 1/52; H01Q 1/22; H01Q 1/38; H01Q 23/00

(52) U.S. Cl. CPC H01Q 1/526; H01Q 1/2283; H01Q 1/38; H01Q 23/00

(57) ABSTRACT

A radio-frequency integrated circuit processes a radio-frequency signal to be transmitted or received by an antenna. The radio-frequency integrated circuit is implemented on a first substrate. The first substrate is implemented on a second substrate. A connector for connection with a cable through which a modulation signal is transferred to the radio-frequency integrated circuit is implemented on the second substrate. A first shield structure covers the connector. An antenna module in which noise due to the connector is less likely to influence antenna characteristics is provided.

### CROSS-REFERENCE TO RELATED APPLICATIONS

The present application is a divisional of U.S. patent application Ser. No. 17/383,456 filed Jul. 23, 2021, which claims priority to PCT/JP2019/050131 filed Dec. 20, 2019 and JP 2019-009221 filed Jan. 23, 2019, the entire contents of each are incorporated herein by reference.

### TECHNICAL FIELD

The present disclosure relates to an antenna module and a communication device.

### BACKGROUND ART

An antenna-integrated module in which a radiation conductor is attached to a substrate on which components including a chip capacitor, a chip resistor, an oscillation circuit, a voltage regulator, a connector, and the like are implemented is described in Patent Document 1. The plurality of components implemented on the substrate is covered with a frame element made of a metal. The frame element has an opening for passing a cable to be connected to a connector.

### CITATION LIST

### Patent Document

Patent Document 1: Japanese Unexamined Patent Application Publication No. 2007-134894

### SUMMARY

### Technical Problem

In the antenna-integrated module described in Patent Document 1, radio-frequency (RF) components including the oscillation circuit and the like, and the connector are covered with the common frame element. Therefore, leakage noise from the connector may be coupled to the radio-frequency components and, as a result, affect antenna characteristics. An aspect of the present disclosure is to provide an antenna module in which noise due to a connector is less likely to influence antenna characteristics. It is another aspect of the present disclosure to provide a communication device using the antenna module.

### Solutions to Problem

According to an aspect of the present disclosure, an antenna module includes a radio-frequency circuit component that processes a radio-frequency signal to be wirelessly communicated, a first substrate on which the radio-frequency circuit component is provided, a connector provided on the first substrate and that connects to a cable that transfers a signal to the radio-frequency circuit component, and a first shield structure that covers at least part of the connector and at least a portion of the first shield structure is disposed between the radio-frequency circuit component and the connector, wherein the first shield structure includes a side plate that surrounds the connector in plan view, and the side plate has an opening that is sized to receive the cable.

According to another aspect of the present disclosure, a communication device includes the antenna module and a baseband integrated circuit that generates a signal to be supplied to the radio-frequency circuit component. The cable connects the connector and the baseband integrated circuit.

### Advantageous Effects

Since the first shield structure covers the connector, one advantageous effect is that leakage noise from the connector is less likely to adversely influence the radio-frequency circuit component. Therefore, an advantageous effect that leakage noise from the connector is less likely to influence the antenna characteristics of the radiating element connected to the radio-frequency circuit component is obtained.

### BRIEF DESCRIPTION OF DRAWINGS

FIG. 1A is a perspective view of an antenna module according to a first embodiment, FIG. 1B is a cross-sectional view of the antenna module, and FIG. 1C is an enlarged cross-sectional view of a portion where a first shield structure is implemented.

FIG. 2 is a block diagram of a communication device in which the antenna module according to the first embodiment is used.

FIG. 3 is a cross-sectional view of an antenna module according to a second embodiment.

FIG. 4A is a cross-sectional view of an antenna module according to a third embodiment, and FIG. 4B is a view showing a planar positional relationship among conductor posts, ground conductor posts, an RFIC, and a ground plane in a first substrate.

FIG. 5 is a cross-sectional view of an antenna module according to a fourth embodiment.

FIG. 6 is a cross-sectional view of an antenna module according to a fifth embodiment and a heat absorbing member to which the antenna module is attached.

FIG. 7A is a cross-sectional view of an antenna module according to a sixth embodiment and a heat absorbing member to which the antenna module is attached, and FIG. 7B is a perspective view of the antenna module according to the sixth embodiment.

FIG. 8 is a perspective view of an antenna module according to a seventh embodiment.

FIG. 9A is a cross-sectional view of an antenna module according to an eighth embodiment, and FIG. 9B is a perspective view of a first shield structure from below.

FIG. 10A is a plan view of an antenna module according to a ninth embodiment, FIG. 10B is a cross-sectional view of the antenna module, and FIG. 10C is a bottom view of the antenna module.

FIG. 11A is a cross-sectional view of an antenna module according to a modification of the ninth embodiment, and FIG. 11B is a bottom view of the antenna module.

FIG. 12A is a cross-sectional view of an antenna module according to a tenth embodiment, and FIG. 12B is a bottom view of the antenna module.

FIG. 13A is a cross-sectional view of an antenna module according to a modification of the tenth embodiment, and FIG. 13B is a bottom view of the antenna module.

FIG. 14A is a cross-sectional view of an antenna module according to an eleventh embodiment, and FIG. 14B is a bottom view of the antenna module.

FIG. 15A is a cross-sectional view of an antenna module according to a modification of the eleventh embodiment, and FIG. 15B is a bottom view of the antenna module.

### DESCRIPTION OF EMBODIMENTS

### First Embodiment

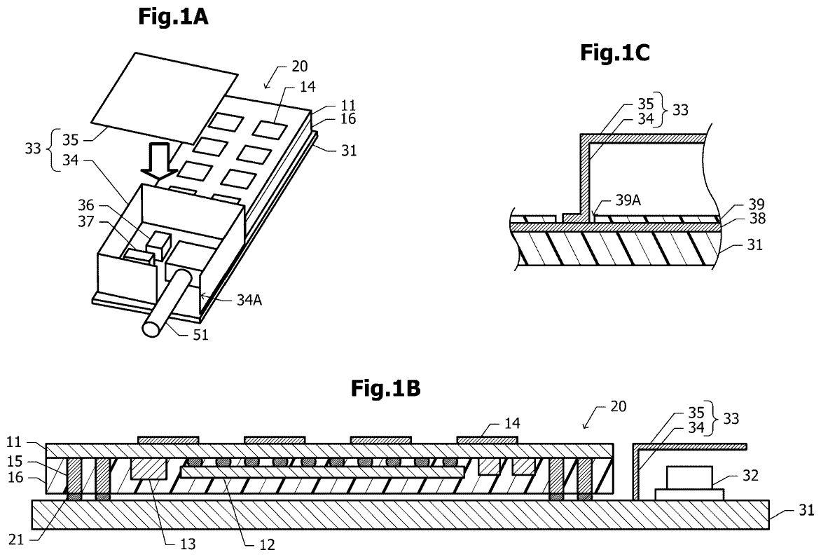

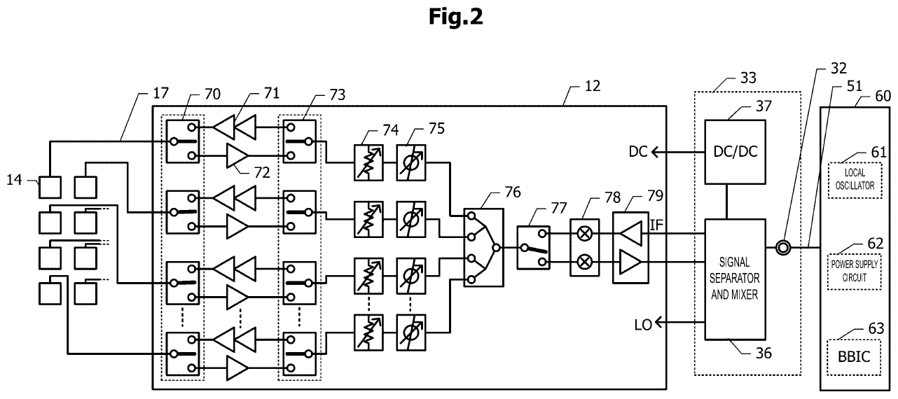

An antenna module according to a first embodiment will be described with reference to FIG. 1A to FIG. 2.

FIG. 1A is a perspective view of the antenna module according to the first embodiment. FIG. 1B is a cross-sectional view of the antenna module. A radio-frequency circuit component 20, a connector 32, a signal separator and mixer 36, a DC-DC converter 37, and the like are implemented on the first substrate 31. The radio-frequency circuit component 20 includes a second substrate 11, a radio-frequency integrated circuit (RFIC) 12, and a plurality of circuit components 13. The radio-frequency integrated circuit 12 and the plurality of circuit components 13 are implemented on one of the surfaces of the second substrate 11. A plurality of radiating elements 14 is provided on (“provided on” as used herein meaning directly, or indirectly on) the opposite side of the second substrate 11. The plurality of radiating elements 14 makes up a patch array antenna. Examples of the circuit components 13 include a bypass capacitor. A plurality of conductor posts 15 is provided upright on the surface of the second substrate 11 on which the RFIC 12 is implemented. The conductor posts 15 are made of, for example, copper (Cu). The RFIC 12, the plurality of circuit components 13, and the plurality of conductor posts 15 are sealed with a sealing resin layer 16. The top face of each of the conductor posts 15 is exposed to the surface of the sealing resin layer 16.

The radiating elements 14 are connected to the RFIC 12. The radiating elements 14 are not always directly connected to the RFIC 12. The radiating elements 14 may be electrically connected to the RFIC 12 via electric supply lines, such as wires and via conductors, provided on or in the second substrate 11. The RFIC 12 is connected to the conductor posts 15. A ground plane is provided (shown in FIG. 1C (described later)) is provided on the first substrate 31, and the ground plane is connected to some of the ground conductor posts 15, intended for grounding.

When the exposed top faces of the conductor posts 15 and lands provided on the surface of the first substrate 31 are electrically and mechanically connected by solder 21, the radio-frequency circuit component 20 is implemented on the first substrate 31. A cable 51 (FIG. 1A) is detachably connected to the connector 32. A signal and the like containing information to be wirelessly communicated are transferred to the RFIC 12 through the cable 51. FIG. 1B shows a state where the cable 51 is not connected to the connector 32.

A first shield structure 33 is provided on the first substrate 31. The first shield structure 33 covers at least part of the connector 32 and shields the connector 32, the signal separator and mixer 36, and the DC-DC converter 37 from surroundings including the RFIC 12. In this specification, an outward normal direction to the surface of the first substrate 31 on which the connector 32 is implemented is defined as upward direction. The first shield structure 33 surrounds the connector 32 in plan view and includes a side plate 34 extending upward from the surface of the first substrate 31 and a top plate 35 closing a top opening portion of the side plate 34. In this way, the first shield structure 33 covers the connector 32 from above and laterally (lateral side). The side plate 34 is disposed at least between the connector 32 and the RFIC 12. The side plate 34 has an opening 34A (FIG. 1A) for extending the cable 51. FIG. 1A shows a state where the top plate 35 is removed from the side plate 34. After the cable 51 is connected to the connector 32, the top plate 35 is attached onto the side plate 34 as indicated by the arrow in FIG. 1A. Thus, the top opening of the side plate 34 is closed with the top plate 35.

FIG. 1C is an enlarged cross-sectional view of a portion where the first shield structure 33 is implemented. A ground plane 38 is provided on the first substrate 31, and the surface of the ground plane 38 is covered with a resist film 39. An opening 39A is provided in part of the resist film 39, and part of the ground plane 38 is exposed inside the opening 39A. The lower end of the side plate 34 of the first shield structure 33 is connected by solder or the like to the ground plane 38 exposed inside the opening 39A.

FIG. 2 is a block diagram of a communication device in which the antenna module according to the first embodiment is used. A mother board 60 of, for example, a personal computer having a communication function, a mobile terminal, such as a mobile phone, a smartphone, and a tablet terminal, or the like, and the connector 32 of the antenna module are connected by the cable 51. For example, a coaxial cable is used as the cable 51. A local oscillator 61, a power supply circuit 62, a baseband integrated circuit (BBIC) 63, and the like are implemented on the mother board 60. The BBIC 63 generates a signal and the like to be supplied to the RFIC 12. A direct-current power, a local oscillation signal, and a signal including information to be wirelessly communicated (for example, an intermediate frequency signal, or the like) are transferred to the antenna module through the cable 51.

These signals are input to the signal separator and mixer 36 through the connector 32 and separated into a local oscillation signal LO and an intermediate frequency signal IF. The local oscillation signal LO and the intermediate frequency signal IF are input to the RFIC 12. The direct-current power transferred through the cable 51 is input to the DC-DC converter 37. The DC-DC converter 37 converts voltage and supplies direct-current power DC at a predetermined voltage to the RFIC 12. The connector 32, the signal separator and mixer 36, and the DC-DC converter 37 are shielded by the first shield structure 33 from the RFIC 12. The RFIC 12 processes a radio-frequency signal to be wirelessly communicated (transmitted or received by the antenna). Hereinafter, the detailed functions of the RFIC 12 will be described.

The intermediate frequency signal IF is input to an up-down conversion mixer 78 via an intermediate frequency amplifier 79. A radio-frequency signal up-converted by the up-down conversion mixer 78 is input to a power divider 76 via a transmission/reception selector switch 77. Radio-frequency signals divided by the power divider 76 are respectively supplied to the plurality of radiating elements 14 via signal phase shifters 75, attenuators 74, transmission/reception selector switches 73, power amplifiers 71, transmission/reception selector switches 70, and electric supply lines 17. The signal phase shifters 75, the attenuators 74, the transmission/reception selector switches 73, the power amplifiers 71, the transmission/reception selector switches 70, and the electric supply lines 17 that process radio-frequency signals divided by the power divider 76 are provided one by one for each of the radiating elements 14.

A radio-frequency signal received by each of the plurality of radiating elements 14 is input to the power divider 76 via the electric supply line 17, the transmission/reception selector switch 70, the low-noise amplifier 72, the transmission/reception selector switch 73, the attenuator 74, and the signal phase shifter 75. A radio-frequency signal synthesized by the power divider 76 is input to the up-down conversion mixer 78 via the transmission/reception selector switch 77. An intermediate frequency signal down-converted by the up-down conversion mixer 78 is passed through the intermediate frequency amplifier 79 and the signal separator and mixer 36, transferred by the cable 51 connected to the connector 32, and input to the BBIC 63 implemented on the mother board 60.

Next, advantageous effects of the first embodiment will be described.

In the first embodiment, the connector 32 is shielded by the first shield structure 33 from the radio-frequency circuit component 20 including the RFIC 12. Therefore, the influence of noise radiated from the connector 32 on the radio-frequency circuit component 20 is reduced. The signal separator and mixer 36 and the DC-DC converter 37 are also shielded by the first shield structure 33 from the radio-frequency circuit component 20, so the influence of noise generated by the signal separator and mixer 36 and the DC-DC converter 37 on the radio-frequency circuit component 20 is reduced.

Next, other examples based on the configuration of the first embodiment will be described. In the first embodiment, a modulation signal, such as an intermediate frequency signal, a local oscillation signal, and a direct-current power are transferred from the mother board 60 (FIG. 2) to the antenna module through the cable 51. Signals to be transferred through the cable 51 between the mother board 60 and the antenna module may include a control signal, a clock signal, and the like. In the first embodiment, a coaxial cable is used as the cable 51, and a connector intended for a coaxial cable is used as the connector 32. Alternatively, a multi-pin connector may be used as the connector 32 according to a cable type.

In the first embodiment, the plurality of radiating elements 14 makes up a patch array antenna. Alternatively, the plurality of radiating elements 14 may make up another antenna. For example, a monopole antenna, a dipole antenna, or the like may be used as the radiating elements 14 of a phased array antenna.

### Second Embodiment

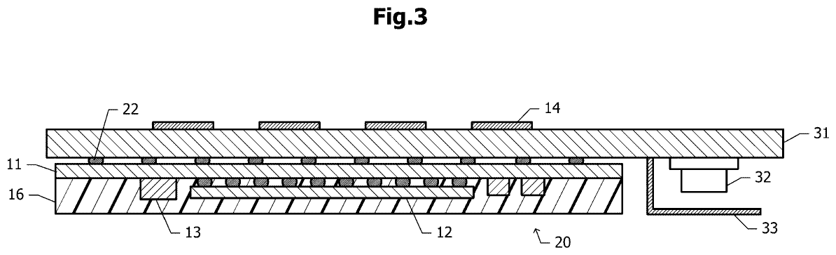

Next, an antenna module according to a second embodiment will be described with reference to FIG. 3. Hereinafter, the description of components common to the antenna module according to the first embodiment is omitted.

FIG. 3 is a cross-sectional view of the antenna module according to the second embodiment. In the first embodiment, the radio-frequency circuit component 20 is implemented on the first substrate 31 in an orientation such that the surface of the second substrate 11 on which the RFIC 12 is implemented faces the first substrate 31. In contrast, in the second embodiment, the radio-frequency circuit component 20 is implemented on the first substrate 31 in an orientation such that the surface of the second substrate 11 on the opposite side of the surface on which the RFIC 12 is implemented faces the first substrate 31. The radio-frequency circuit component 20 is electrically and mechanically connected to the first substrate by solder 22. In the second embodiment, no conductor post 15 (FIG. 1B) is provided in the radio-frequency circuit component 20.

In the first embodiment, the radiating elements 14 (FIG. 1B) are provided on the second substrate 11; whereas, in the second embodiment, the plurality of radiating elements 14 is provided on the surface of the first substrate 31 on the opposite side of the surface on which the radio-frequency circuit component 20 is implemented. The plurality of radiating elements 14 is connected to the RFIC 12 via transmission lines provided on or in the first substrate 31, the solder 22, and transmission lines provided on or in the second substrate 11.

In the second embodiment, as well as the first embodiment, the connector 32 is implemented on the first substrate 31, and the first shield structure 33 shields the connector 32 from the radio-frequency circuit component 20 including the RFIC 12.

Next, advantageous effects of the second embodiment will be described.

In the second embodiment, as well as the first embodiment, the connector 32 is shielded from the radio-frequency circuit component 20 including the RFIC 12. Therefore, the influence of noise radiated from the connector 32 on the radio-frequency circuit component 20 is reduced.

### Third Embodiment

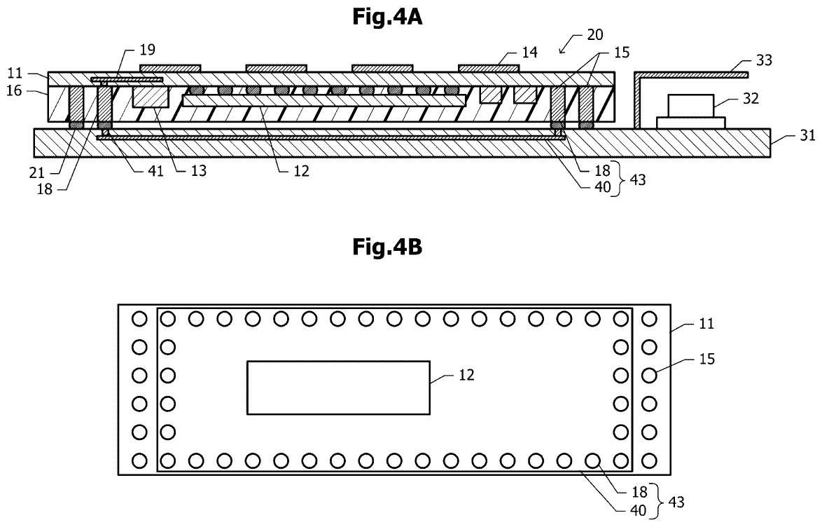

Next, an antenna module according to a third embodiment will be described with reference to FIG. 4A and FIG. 4B. Hereinafter, the description of components common to the antenna module according to the first embodiment is omitted.

FIG. 4A is a cross-sectional view of the antenna module according to the third embodiment. A ground plane 40 is disposed in the internal layer of the first substrate 31. Some of the plurality of conductor posts 15 on the second substrate 11 are ground conductor posts 18. The ground conductor posts 18 are connected to a ground plane 19 in the second substrate 11. The ground plane 40 in the first substrate 31 is connected to the ground conductor posts 18 via the solder 21 and a plurality of via conductors 41 disposed in the first substrate 31.

FIG. 4B is a view showing a planar positional relationship among the conductor posts 15, the ground conductor posts 18, the RFIC 12, and the ground plane 40 in the first substrate 31. The plurality of ground conductor posts 18 is disposed so as to surround the RFIC 12. The RFIC 12 is disposed in the ground plane 40. The ground plane 40 overlaps the ground conductor posts 18 and is connected to the ground conductor posts 18. The conductor posts 15 other than the ground conductor posts 18 are disposed outside the ground plane 40.

The ground plane 40 and the plurality of ground conductor posts 18 make up a second shield structure 43. The second shield structure 43 covers the RFIC 12 that is part of the radio-frequency circuit component 20 and shields the RFIC 12 from surroundings including the connector 32 (FIG. 4A).

Next, advantageous effects of the third embodiment will be described.

In the third embodiment, as well as the first embodiment, the influence of noise radiated from the connector 32 on the radio-frequency circuit component 20 is reduced.

In the third embodiment, the second shield structure 43 shields the RFIC 12, so an advantageous effect that the RFIC 12 is not susceptible to noise generated from the connector 32 and noise generated from peripheral elements, such as elements implemented on the mother board 60 (FIG. 2), is obtained. In addition, the influence of noise generated from the RFIC 12 on the connector 32 and the peripheral elements is reduced.

### Fourth Embodiment

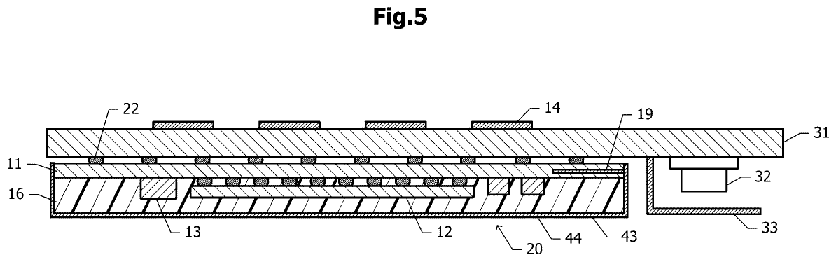

Next, an antenna module according to a fourth embodiment will be described with reference to FIG. 5. Hereinafter, the description of components common to the antenna module (FIG. 3) according to the second embodiment is omitted.

FIG. 5 is a cross-sectional view of the antenna module according to the fourth embodiment. In the fourth embodiment, the surface of the sealing resin layer 16 is covered with an electrically conductive film 44. The electrically conductive film 44 is connected to a ground plane 19 provided in the second substrate 11. The electrically conductive film 44 functions as the second shield structure 43. The second shield structure 43 covers the RFIC 12 and is disposed at least between the connector 32 and the RFIC 12.

Next, advantageous effects of the fourth embodiment will be described.

In the fourth embodiment, as well as the first embodiment, the influence of noise radiated from the connector 32 on the radio-frequency circuit component 20 is reduced.

In the fourth embodiment, the electrically conductive film 44 functions as the second shield structure 43, so, as well as the third embodiment, an advantageous effect that the RFIC 12 is not susceptible to noise generated from the connector 32 and noise generated from peripheral elements, such as elements implemented on the mother board 60 (FIG. 2), is obtained. In addition, the influence of noise generated from the RFIC 12 on the connector 32 and the peripheral elements is reduced.

### Fifth Embodiment

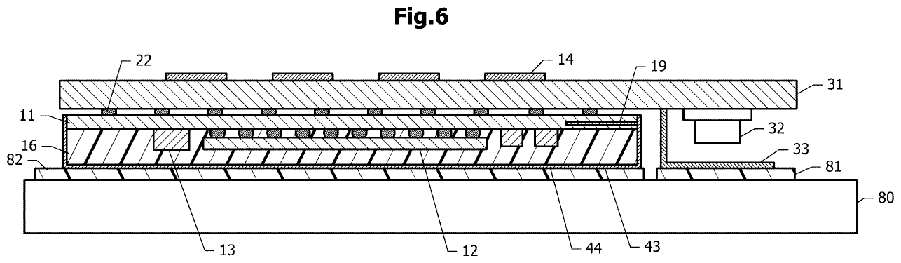

Next, an antenna module according to a fifth embodiment will be described with reference to FIG. 6. Hereinafter, the description of components common to the antenna module (FIG. 5) according to the fourth embodiment is omitted.

FIG. 6 is a cross-sectional view of the antenna module according to the fifth embodiment and a heat absorbing member 80 to which the antenna module is attached. A heat dissipation member 81 is stuck to the surface (hereinafter, referred to as top surface) of the first shield structure 33, facing away from the first substrate 31. A heat dissipation member 82 is stuck to the surface (hereinafter, referred to as top surface) of the second shield structure 43, facing away from the first substrate 31. The first shield structure 33 and the second shield structure 43 are respectively thermally coupled to the heat absorbing member 80 via the heat dissipation members 81, 82. Here, the term “thermal coupling” means coupling in a state where heat is conductible between a plurality of coupled physical objects. For example, a soft, highly adhesive, highly thermally conductive sheet material (heat dissipation sheet or thermally conductive sheet) may be used as the heat dissipation members 81, 82. For example, a metal portion of the mother board 60 (FIG. 2), a casing in which the antenna module is accommodated, a heat sink, or the like may be used as the heat absorbing member 80.

The heat dissipation member 81 has a function to efficiently conduct heat between the first shield structure 33 and the heat absorbing member 80, and the heat dissipation member 82 has a function to efficiently conduct heat between the second shield structure 43 and the heat absorbing member 80.

Next, advantageous effects of the fifth embodiment will be described.

In the fifth embodiment, as well as the fourth embodiment, the influence of noise radiated from the connector 32 on the radio-frequency circuit component 20 is reduced.

In the fifth embodiment, the first shield structure 33 and the heat dissipation member 81 function as a heat conduction path from components shielded by the first shield structure 33, for example, the connector 32, the signal separator and mixer 36 (FIG. 2), and the DC-DC converter 37 (FIG. 2), to the heat absorbing member 80. Therefore, heat is efficiently dissipated from the connector 32, the signal separator and mixer 36 (FIG. 2), and the DC-DC converter 37 (FIG. 2). In addition, the sealing resin layer 16, the second shield structure 43, and the heat dissipation member 82 are disposed without almost any gap between the RFIC 12 and the heat absorbing member 80, so heat is efficiently dissipated from the RFIC 12.

By aligning the height from the first substrate 31 to the top surface of the first shield structure 33 with the height from the first substrate 31 to the top surface of the second shield structure 43, the antenna module can be easily brought into close contact with the flat surface of the heat absorbing member 80 via the heat dissipation members 81, 82. Preferably, the difference between the height from the first substrate 31 to the top surface of the first shield structure 33 and the height from the first substrate 31 to the top surface of the second shield structure 43 is set to such an extent that the difference can be absorbed by the flexibility of the heat dissipation members 81, 82. In this case, members having the same thickness may be used as the heat dissipation members 81, 82. A continuous single heat dissipation member may be used as the heat dissipation members 81, 82.

Next, a modification of the fifth embodiment will be described. In the fifth embodiment, the heat dissipation member 82 is stuck to the top surface of the second shield structure 43. Alternatively, without providing the second shield structure 43, the heat dissipation member 82 may be stuck to the top surface of the sealing resin layer 16 (FIG. 3) according to the second embodiment.

### Sixth Embodiment

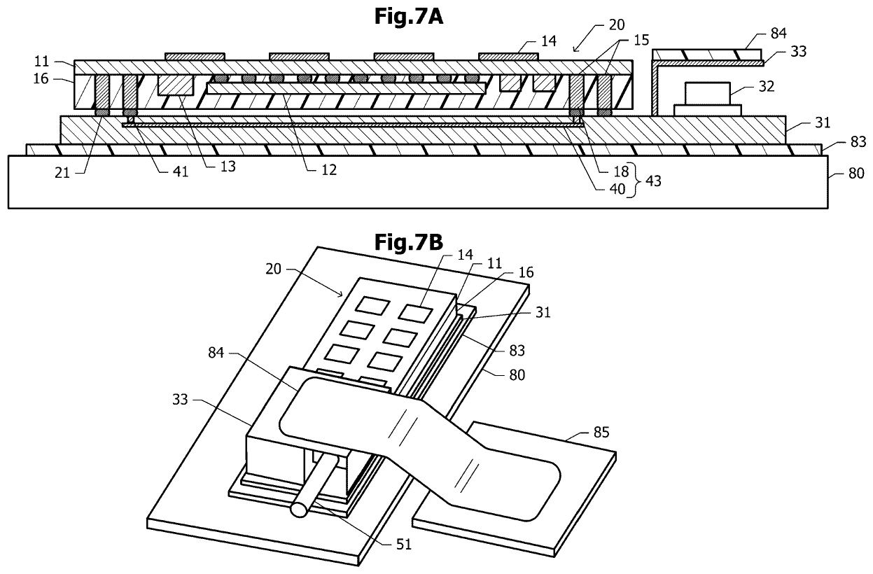

Next, an antenna module according to a sixth embodiment will be described with reference to FIG. 7A and FIG. 7B. Hereinafter, the description of components common to the antenna module (FIG. 4A and FIG. 4B) according to the third embodiment is omitted.

FIG. 7A is a cross-sectional view of the antenna module according to the sixth embodiment and the heat absorbing member 80 to which the antenna module is attached. FIG. 7B is a perspective view of the antenna module and the heat absorbing member 80. A heat dissipation member 83 is stuck to the surface of the first substrate 31 on the opposite side of the surface on which the radio-frequency circuit component 20 is implemented. The heat dissipation member 83 is in close contact with the heat absorbing member 80.

In addition, another heat dissipation member 84 is stuck to the top surface of the first shield structure 33. The heat dissipation member 84 extends to the outside of the first substrate 31 in plan view and is in close contact with a heat absorbing member 85 located near the antenna module. For example, a metal portion of the mother board, a casing in which the antenna module is accommodated, a heat sink, or the like may be used as the heat absorbing member 85.

Next, advantageous effects of the sixth embodiment will be described.

In the sixth embodiment, as well as the third embodiment, the influence of noise radiated from the connector 32 on the radio-frequency circuit component 20 is reduced.

In the sixth embodiment, heat generated from the RFIC 12 and the like is efficiently dissipated through the second substrate 11, the conductor posts 15, the solder 21, the first substrate 31, and the heat dissipation member 83. In addition, heat generated from components in a region surrounded by the first shield structure 33 is efficiently dissipated through the first shield structure 33 and the heat dissipation member 84.

Generally, the heights of components including the signal separator and mixer 36, the DC-DC converter 37 (FIG. 1A), and the like, disposed near the connector 32 are different. When a plurality of components having different heights is implemented in this way, it is difficult to stick a single heat dissipation member resistant to deformation to the top surfaces of these components. In the sixth embodiment, the heat dissipation member 84 just needs to be brought into close contact with the flat top surface of the first shield structure 33, so an advantageous effect that it is easy to stick the heat dissipation member 84 is obtained.

### Seventh Embodiment

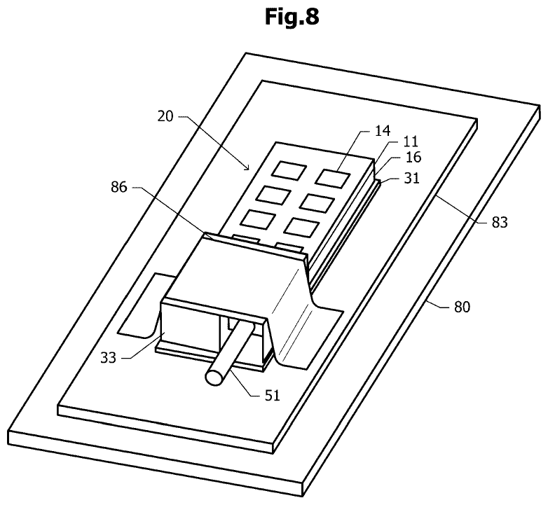

Next, an antenna module according to a seventh embodiment will be described with reference to FIG. 8. Hereinafter, the description of components common to the antenna module (FIG. 7A and FIG. 7B) according to the sixth embodiment is omitted.

FIG. 8 is a perspective view of the antenna module according to the seventh embodiment. In the sixth embodiment (FIG. 7B), the heat dissipation member 84 in close contact with the top surface of the first shield structure 33 is in close contact with the heat absorbing member 85 near the antenna module. In contrast, in the seventh embodiment, a heat dissipation member 86 in close contact with the top surface of the first shield structure 33 is in close contact with the heat dissipation member 83 stuck to the first substrate 31.

Next, advantageous effects of the seventh embodiment will be described.

In the seventh embodiment, as well as the sixth embodiment, the influence of noise radiated from the connector 32 on the radio-frequency circuit component 20 is reduced.

In addition, in the seventh embodiment, heat generated from components in a region surrounded by the first shield structure 33 is efficiently dissipated through the first shield structure 33, the heat dissipation member 86, and the other heat dissipation member 83 to the heat absorbing member 80 in close contact with the heat dissipation member 83.

### Eighth Embodiment

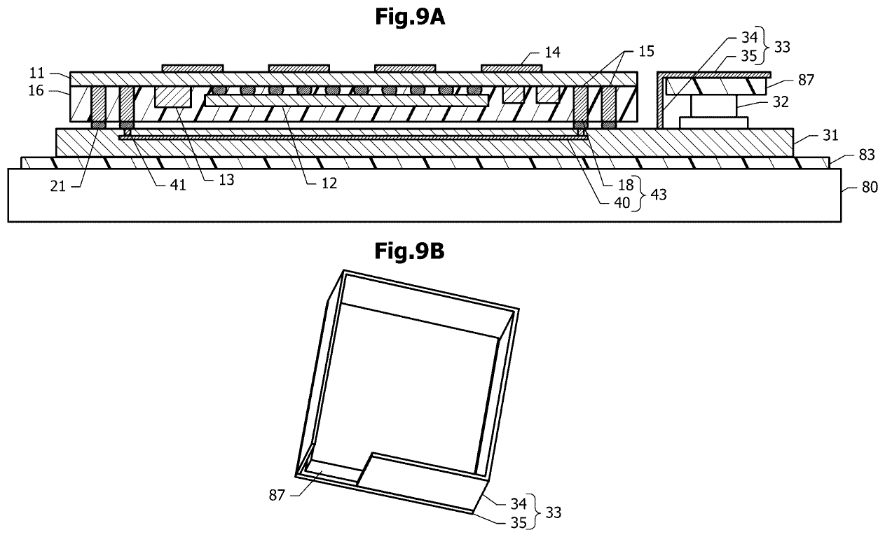

Next, an antenna module according to an eighth embodiment will be described with reference to FIG. 9A and FIG. 9B. Hereinafter, the description of components common to the antenna module (FIG. 7A and FIG. 7B) according to the sixth embodiment is omitted.

FIG. 9A is a cross-sectional view of the antenna module according to the eighth embodiment, and FIG. 9B is a perspective view of the first shield structure 33 from below. In the sixth embodiment (FIG. 7A and FIG. 7B), the heat dissipation member 84 is stuck to the top surface of the first shield structure 33. In contrast, in the eighth embodiment, a heat dissipation member 87 is stuck to the surface of the top plate 35 of the first shield structure 33, facing the first substrate 31. The heat dissipation member 87 is in close contact with the top surfaces of components shielded by the first shield structure 33, including, for example, the connector 32 (FIG. 9A), the signal separator and mixer 36 (FIG. 1A), the DC-DC converter 37 (FIG. 1A), and the like. When the top plate 35 of the first shield structure 33 is attached to the side plate 34 in a state where the cable 51 (FIG. 1A) is connected to the connector 32, the heat dissipation member 87 is in close contact with a connector portion of the cable 51. When the heights of the plurality of components are different, the heat dissipation member 87 deforms due to the flexibility of the heat dissipation member 87, with the result that the heat dissipation member 87 is in close contact with the top surfaces of these components.

Next, advantageous effects of the eighth embodiment will be described.

In the eighth embodiment, as well as the sixth embodiment, the influence of noise radiated from the connector 32 on the radio-frequency circuit component 20 is reduced.

In the eighth embodiment, heat generated from the signal separator and mixer 36, the DC-DC converter 37 (FIG. 1A), and the like is directly conducted to the first substrate 31 and is also conducted to the first substrate 31 through the heat dissipation member 87 and the first shield structure 33. Heat conducted to the first substrate 31 is absorbed by the heat absorbing member 80 through the heat dissipation member 83. Therefore, heat generated from the heat dissipation member 87 and the first shield structure 33 is efficiently dissipated.

In addition, the surface of the top plate 35 of the first shield structure 33, facing the first substrate 31, is flat, so the heat dissipation member 87 is easily stuck. Even when the heights of the plurality of components are different, the heat dissipation member 87 is easily brought into close contact with the plurality of components due to the flexibility of the heat dissipation member 87.

### Ninth Embodiment

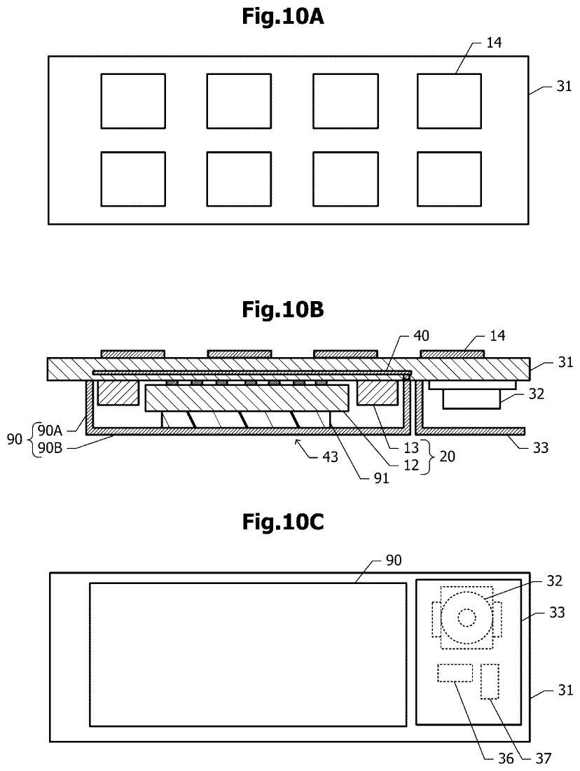

Next, an antenna module according to a ninth embodiment will be described with reference to FIG. 10A, FIG. 10B, and FIG. 10C. Hereinafter, the description of components common to the antenna module (FIG. 5) according to the fourth embodiment is omitted.

FIG. 10A is a plan view of the antenna module according to the ninth embodiment, FIG. 10B is a cross-sectional view of the antenna module, and FIG. 10C is a bottom view of the antenna module. In the fourth embodiment (FIG. 5), the radio-frequency integrated circuit 12 and the plurality of circuit components 13 are implemented on the second substrate 11 that functions as an interposer to make up the radio-frequency circuit component 20. The radio-frequency integrated circuit 12 and the plurality of circuit components 13 are implemented on the first substrate 31 via the second substrate 11. In contrast, in the ninth embodiment, the radio-frequency integrated circuit 12 and the plurality of circuit components 13 are directly implemented on the first substrate 31. In the ninth embodiment, the radio-frequency circuit component 20 includes the radio-frequency integrated circuit 12 and the plurality of circuit components 13, directly implemented on the first substrate 31.

A shield case 90 covers the radio-frequency circuit component 20. The shield case 90 includes a side plate 90A and a top plate 90B. The side plate 90A surrounds the radio-frequency integrated circuit 12 and the plurality of circuit components 13 in a state where the first substrate 31 is viewed in plan. The top plate 90B closes an opening portion of the side plate 90A. The shield case 90 is electrically connected to the ground plane 40 provided in the internal layer of the first substrate 31. The shield case 90 and the ground plane 40 function as the second shield structure 43.

A heat dissipation member 91 is disposed between the radio-frequency integrated circuit 12 and the top plate 90B of the shield case 90, and the radio-frequency integrated circuit 12 and the top plate 90B of the shield case 90 are thermally coupled by the heat dissipation member 91.

Next, advantageous effects of the ninth embodiment will be described.

In the ninth embodiment, as well as the fourth embodiment, the influence of noise radiated from the connector 32, the signal separator and mixer 36, the DC-DC converter 37, and the like on the radio-frequency circuit component 20 is reduced. In addition, in the ninth embodiment, when the top plate 90B of the shield case 90 is attached to the heat absorbing member 80 via the heat dissipation member 82 as in the case of the fifth embodiment (FIG. 6), the heat dissipation member 91 functions as part of a heat dissipation path, so heat is efficiently dissipated.

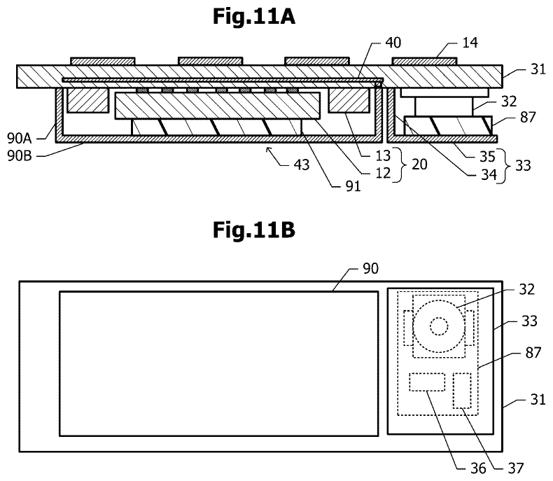

Next, a modification of the ninth embodiment will be described with reference to FIG. 11A and FIG. 11B.

FIG. 11A is a cross-sectional view of an antenna module according to the modification of the ninth embodiment, and FIG. 11B is a bottom view of the antenna module. In the ninth embodiment (FIG. 10B), a cavity is formed between the top plate 35 of the first shield structure 33 and the connector 32, the signal separator and mixer 36, and the DC-DC converter 37. In contrast, in this modification, as well as the eighth embodiment (FIG. 9A and FIG. 9B), the heat dissipation member 87 is disposed between the top plate 35 of the first shield structure 33 and each of the connector 32, the signal separator and mixer 36, and the DC-DC converter 37. Therefore, heat generated from the connector 32, the signal separator and mixer 36, the DC-DC converter 37, and the like is efficiently dissipated through the heat dissipation member 87 and the first shield structure 33.

### Tenth Embodiment

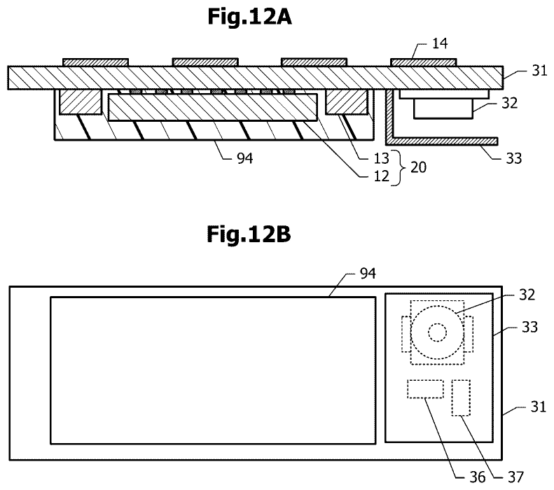

Next, an antenna module according to a tenth embodiment will be described with reference to FIG. 12A and FIG. 12B. Hereinafter, the description of components common to the antenna module (FIG. 10A, FIG. 10B, and FIG. 10C) according to the ninth embodiment is omitted.

FIG. 12A is a cross-sectional view of the antenna module according to the tenth embodiment, and FIG. 12B is a bottom view of the antenna module. In the ninth embodiment (FIG. 10B), the radio-frequency integrated circuit 12 and the plurality of circuit components 13 are covered with the shield case 90. In contrast, in the tenth embodiment, the radio-frequency integrated circuit 12 and the plurality of circuit components 13 are sealed with a sealing resin layer 94. In other words, the radio-frequency circuit component 20 is sealed with the sealing resin layer 94.

Next, advantageous effects of the tenth embodiment will be described.

In the tenth embodiment, as well as the ninth embodiment, the influence of noise radiated from the connector 32, the signal separator and mixer 36, the DC-DC converter 37, and the like on the radio-frequency circuit component 20 is reduced.

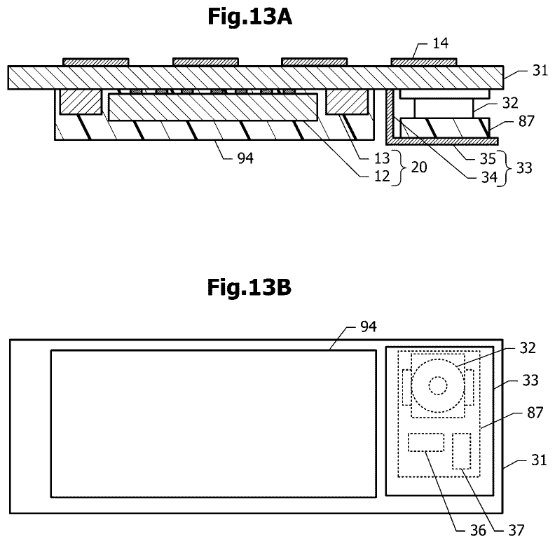

Next, a modification of the tenth embodiment will be described with reference to FIG. 13A and FIG. 13B.

FIG. 13A is a cross-sectional view of an antenna module according to the modification of the tenth embodiment, and FIG. 13B is a bottom view of the antenna module. In this modification, as in the case of the antenna module (FIG. 11A and FIG. 11B) according to the modification of the ninth embodiment, the heat dissipation member 87 is disposed between the top plate 35 of the first shield structure 33 and each of the connector 32, the signal separator and mixer 36, and the DC-DC converter 37. Therefore, heat generated from the connector 32, the signal separator and mixer 36, the DC-DC converter 37, and the like is efficiently dissipated through the heat dissipation member 87 and the first shield structure 33.

### Eleventh Embodiment

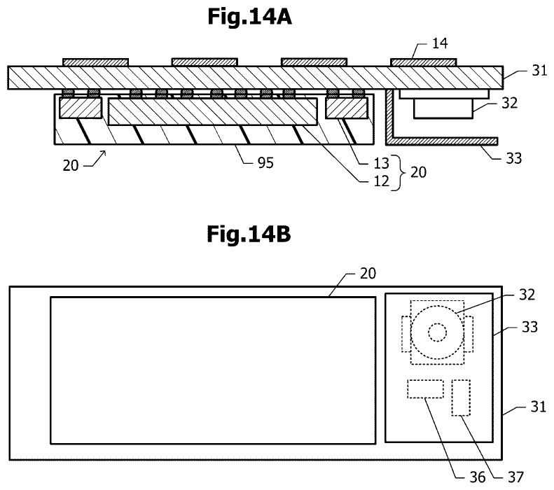

Next, an antenna module according to an eleventh embodiment will be described with reference to FIG. 14A and FIG. 14B. Hereinafter, the description of components common to the antenna module (FIG. 3) according to the second embodiment is omitted.

FIG. 14A is a cross-sectional view of an antenna module according to the eleventh embodiment, and FIG. 14B is a bottom view of the antenna module. In the second embodiment (FIG. 3), the radio-frequency circuit component 20 includes the second substrate 11 called interposer. In contrast, in the eleventh embodiment, the radio-frequency circuit component 20 has a so-called interposer-less structure. The radio-frequency circuit component 20 including the radio-frequency integrated circuit 12 and the plurality of circuit components 13 is implemented on the first substrate 31.

Hereinafter, an example of a manufacturing method for the radio-frequency circuit component 20 used in the antenna module according to the eleventh embodiment will be described. The radio-frequency integrated circuit 12 and the plurality of circuit components 13 are positioned and mounted on a temporary support substrate on which an adhesion layer is provided. In this state, the radio-frequency integrated circuit 12 and the plurality of circuit components 13 are covered with a resin, such as epoxy resin. After the resin is cured, the temporary support substrate is removed together with the adhesion layer. Through these steps, the radio-frequency circuit component 20 is manufactured.

Next, advantageous effects of the eleventh embodiment will be described.

In the eleventh embodiment, as well as the second embodiment, the influence of noise radiated from the connector 32, the signal separator and mixer 36, the DC-DC converter 37, and the like on the radio-frequency circuit component 20 is reduced.

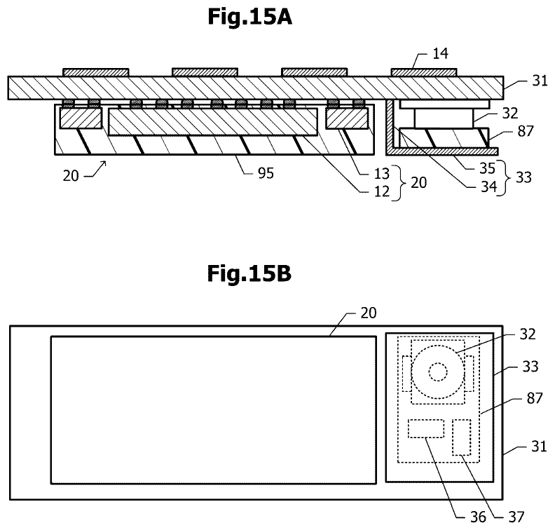

Next, a modification of the eleventh embodiment will be described with reference to FIG. 15A and FIG. 15B.

FIG. 15A is a cross-sectional view of an antenna module according to the modification of the eleventh embodiment, and FIG. 15B is a bottom view of the antenna module. In this modification, as in the case of the antenna module (FIG. 11A and FIG. 11B) according to the modification of the ninth embodiment, the heat dissipation member 87 is disposed between the top plate 35 of the first shield structure 33 and each of the connector 32, the signal separator and mixer 36, and the DC-DC converter 37. Therefore, heat generated from the connector 32, the signal separator and mixer 36, the DC-DC converter 37, and the like is efficiently dissipated through the heat dissipation member 87 and the first shield structure 33.

The above-described embodiments are illustrative, and, of course, partial replacements or combinations of components described in different embodiments are possible. Similar operation and advantageous effects with similar components of some of the embodiments will not be repeated one by one for each embodiment. The present disclosure is not limited to the above-described embodiments. It is obvious to persons skilled in the art that, for example, various modifications, improvements, combinations, and the like are possible.

### REFERENCE SIGNS LIST

11 second substrate
12 radio-frequency integrated circuit (RFIC)
13 circuit component
14 radiating element
15 conductor post
16 sealing resin layer
17 electric supply line
18 ground conductor post
19 ground plane
20 radio-frequency circuit component
21, 22 solder
31 first substrate
32 connector
33 first shield structure
34 side plate
34A opening
35 top plate
36 signal separator and mixer
37 DC-DC converter
38 ground plane
39 resist film
39A opening
40 ground plane
41 via conductor
43 second shield structure
44 electrically conductive film
51 cable
60 mother board
61 local oscillator
62 power supply circuit
63 baseband integrated circuit (BBIC)
70 transmission/reception selector switch
71 power amplifier
72 low-noise amplifier
73 transmission/reception selector switch
74 attenuator
75 signal phase shifter
76 power divider
77 transmission/reception selector switch
78 up-down conversion mixer
79 intermediate frequency amplifier
80 heat absorbing member
81, 82, 83, 84 heat dissipation member
85 heat absorbing member
86, 87 heat dissipation member
90 shield case
90A side plate
90B top plate
91 heat dissipation member
94 sealing resin layer

1. An antenna module comprising:
a radio-frequency circuit component that processes a radio-frequency signal to be wirelessly communicated;
a first substrate on which the radio-frequency circuit component is provided;
a connector provided on the first substrate and that connects to a cable that transfers a signal to the radio-frequency circuit component; and
a first shield structure that covers at least part of the connector and at least a portion of the first shield structure is disposed between the radio-frequency circuit component and the connector, wherein
the first shield structure includes a side plate that surrounds the connector in plan view, and
the side plate has an opening that is sized to receive the cable.

2. The antenna module according to claim 1, wherein, under a condition that an upward direction is a direction in which a surface of the first substrate on which the connector is provided faces, the first shield structure covers the connector from above and laterally.

3. The antenna module according to claim 1, further comprising a second shield structure that covers at least part of the radio-frequency circuit component.

4. The antenna module according to claim 2, further comprising a second shield structure that covers at least part of the radio-frequency circuit component.

5. The antenna module according to claim 3, wherein at least a portion of the second shield structure is disposed between the connector and the radio-frequency circuit component.

6. The antenna module according to claim 4, wherein at least a portion of the second shield structure is disposed between the connector and the radio-frequency circuit component.

7. The antenna module according to claim 3, wherein
the radio-frequency circuit component includes
a second substrate,
a radio-frequency integrated circuit disposed on the second substrate,
a sealing resin layer that seals the radio-frequency integrated circuit, and
a conductor post embedded in the sealing resin layer,
the second shield structure includes
a first ground plane provided on or in the first substrate, and
a second ground plane provided on or in the second substrate, and
the conductor post electrically connects the first ground plane and the second ground plane and is part of the second shield structure.

8. The antenna module according to claim 5, wherein
the radio-frequency circuit component includes
a second substrate,
a radio-frequency integrated circuit disposed on the second substrate,
a sealing resin layer that seals the radio-frequency integrated circuit, and
a conductor post embedded in the sealing resin layer,
the second shield structure includes
a first ground plane provided on or in the first substrate, and
a second ground plane provided on or in the second substrate, and
the conductor post electrically connects the first ground plane and the second ground plane and is part of the second shield structure.

9. The antenna module according to claim 1, further comprising a radiating element provided on the second substrate, wherein the radiating element is connected to the radio-frequency circuit component.

10. The antenna module according to claim 1, further comprising a first heat dissipation member thermally coupled to the first shield structure.

11. The antenna module according to claim 2, further comprising a first heat dissipation member thermally coupled to the first shield structure.

12. The antenna module according to claim 3, further comprising a second heat dissipation member thermally coupled to the second shield structure.

13. A communication device comprising:
the antenna module having a radio-frequency component that processes a radio-frequency signal to be wirelessly communicated; and
a baseband integrated circuit configured to generate a signal and supply the signal to the radio-frequency circuit component, wherein the antenna module includes
the radio-frequency circuit,
a first substrate on which the radio-frequency circuit component is provided,
a connector provided on the first substrate and that connects to a cable that transfers a signal to the radio-frequency circuit component, and
a first shield structure that covers at least part of the connector and at least a portion of the first shield structure is disposed between the radio-frequency circuit component and the connector, wherein
the first shield structure includes a side plate that surrounds the connector in plan view,
the side plate has an opening that is sized to receive the cable, and
the cable connects the connector and the baseband integrated circuit.
